(19) United States
(12) Patent Application Publication
(10) Pub. No.: US 2011/0316189 A1
(43) Pub. Date: Dec. 29, 2011

(54) SELF-MENDING COMPOSITES INCORPORATING ENCAPSULATED MENDING AGENTS

(75) Inventors: Michelle Pelletier, Woonsocket, RI (US); Arijit Bose, Lexington, MA (US)

(73) Assignee: Board of Governors for Higher Education, State of Rhode Island and Providence Plantations, Providence, RI (US)

(21) Appl. No.: 13/168,456

(22) Filed: Jun. 24, 2011

Related U.S. Application Data
(60) Provisional application No. 61/358,435, filed on Jun. 25, 2010.

(51) Int. Cl. C04B 24/14; C04B 28/04; B28B 5/00; C04B 28/26

(52) U.S. Cl. 264/228; 106/606; 106/713; 524/8; 524/4; 106/737; 106/14.05; 524/5; 524/6; 106/645

(57) ABSTRACT

A cement mixture is disclosed that includes an aqueous mending agent that is disbursed within but isolated from the cement mixture, wherein the aqueous mending agent will form molecular bonds with hardened cement that is formed by the cement mixture when the mending agent is permitted to flow within the hardened cement.

### PRIORITY

The present application claims priority to U.S. Provisional Patent Application Ser. No. 61/358,435 filed Jun. 25, 2010.

### BACKGROUND

Cement and concrete are the most commonly used building materials in the world. As used herein, the term “cement” means a composite material that includes any of limestone, calcium, silicon, iron, aluminum or gypsum, and includes concrete, which is generally used to refer to cement with sand or gravel added to the cement.

Cement is strong, durable, locally available and versatile. It is also an inexpensive material to produce and is recyclable. Unfortunately, cement is susceptible to many sources of damage. Cracks may form at any stage of its fife and most begin internally where they cannot be seen for years until major repairs are needed. Damage is caused by a number of factors such as freeze/thaw cycles, corrosion, extreme loads, chemical attacks and other environmental conditions. Consequently, maintenance to cement structures is frequent and costly. Billions of dollars are spent every year on buildings, bridges and highways for maintenance, making materials requiring less frequent repairs very appealing. In addition, the production of cement is an energy-intensive process considering the mining, transportation and processing requirements. Its production level lies at about 2.35 billion metric tons per year and contributes an astonishing 10% of CO₂ emissions into the atmosphere.

Typically damage, deterioration and overall structural integrity are conventionally monitored through routine inspections and repair. Inspections may involve surface washing and corrosion monitoring. Repairs may involve a variety of approaches that includes one or more of the following: surface repairs, apply admixtures and sealant applications. In the past decade, the building industry has taken a significant interest in engineering concrete as a smart material to alleviate the cost burden to maintain roads from excessive routine maintenance and excessive cement production. The more conventional approaches have used chemical admixtures to limit the scale of damage.

U.S. Pat. No. 7,513,948, for example, discloses incorporating branched hydrocarbons as part of a mixture of compounds that may be either added to the cement mixture or applied to hardened concrete surfaces. The branched hydrocarbon mixture is disclosed to provide a higher degree of moisture resistance by filling cracks that form and by bonding to reinforcement bars (rebars) in the hardened cement.

U.S. Pat. No. 7,572,501 discloses embedding short fibers into cement mixtures to control crack width and improve tensile strain capacity. The fibers are disclosed to be formed of aromatic polyamide, polyethylene, polyvinyl alcohol, polypropylene, carbon, cellulose and steel. Limiting the formation of microcracks to 50 μm or less in width in the damaged material is disclosed to have been accomplished. The reference also discloses that cracks may be healed by flowing water containing carbonates and bicarbonates into the crack, which promotes the formation of calcium carbonate.

U.S. Pat. No. 6,261,360 discloses incorporating hollow fibers in a cement mixture wherein modifying agents are provided within the fibers. The modifying agents are disclosed to be polymerizable monomers such as methacrylates, styrene or other polymerizable starting material, as well as epoxies. The fibers are disclosed to be formed of any of fiberglass, cement, asphalt, hydroxyapatite, glass, ceramic, metal, polyolefin, polyester, polyamide, polyaramide, polyimide, carbon, graphite, cellulose, nitrocellulose, hydrocarbon, and GORTEX® and KEVLAR® materials. The reference discloses that the modifying agents may be released from the fibers by application of pressure, electrical stimulation, magnetic stimulation, acoustic excitation, and application of laser illumination or a seismic field.

U.S. Published Patent Application Publication No. 2008/0299391 discloses providing microcapsules (e.g., 10 micrometers) within structures such as thin films that are susceptible to cracking. Some capsules are disclosed to contain a polymerizable monomer such as styrene, ethylene, acrylates, methacrylates, and diclopentadiene, and other capsules are disclosed to contain an activator. Upon crack propagation, the activator causes the monomer to polymerize and fill the crack.

The prior methods used to promote self-healing of cement generally employ compositions of material that act to produce polymeric or aggregate materials inside the microcrack to act as filler in the damaged structure. There remains a need, however, for methods of manufacturing and using cement mixtures that further prolongs the life of the hardened cement by either preventing damage to the hardened concrete or more effectively repairing the hardened cement in situ.

### SUMMARY OF THE INVENTION

The present invention is directed to a system and a method of mending cement damaged by an external stress by incorporating microcapsules containing an aqueous mending agent into the cement matrix that when released by an external stress mends one or more properties of the cement. More preferably, the invention is directed to providing a targeted release of the aqueous mending agent by rupturing of the microcapsule during the formation of a microcrack due to stress. Most preferably, the aqueous mending agent reacts with endogenous products of cement hydration in the damaged concrete to produce a natural cement bond that mends the damaged hardened cement.

In another aspect, the invention herein is directed to providing a method of reducing the corrosion of metal reinforcement incorporated in the hardened cement for strengthening properties. A further aspect of the present invention is the treatment of metal reinforcement with aqueous mending agent microcapsules prior to the addition of the cement mixture.

In a first aspect of the invention, the cement matrix containing aqueous mending agent microcapsules is able to improve at least one of the cement properties by at least 10% compared to cement mixtures that do not incorporate the microcapsules of the invention matrix when the hardened cement is damaged by stress. More preferably, the improvement is at least 25%, and most preferably the improvement is at least 50%.

In a second aspect of the invention, the aqueous mending agent may be aqueous sodium silicate, calcium nitrite or any other mending agent that binds on a molecular level with the hardened damaged cement.

In a third aspect of the invention, the aqueous mending agent used in microcapsulation is a solution of 0.1% to 10% aqueous mending agent.

In a fourth aspect of the invention, the microcapsule material is a polymer, such as polyurethane, urea-formaldehyde polymer, a polystyrene or polymide, a gelatin, or any other material used to encapsulate the aqueous mending agent or combinations thereof.

In a fifth aspect of the invention, the external stress creating a microcrack and the targeted rupturing of the microcapsule in the microcrack region may be caused by freezing, thawing, loading, cracking, impacting, corrosion, weight, chemical, creep, expansion, shrinkage or combinations thereof.

In a sixth aspect of the invention, the aqueous mending agent microcapsule is added from 0.5% to 25.0% by weight of the cement mixture.

In a seventh aspect of the invention, the improved damaged cement property is one or more of the following; tensile strength, toughness, porosity, and water permeability.

In an eighth aspect of the invention, the cement matrix containing the aqueous mending agent microcapsules reduces corrosion of metal reinforcement within the hardened cement by at least 10% compared to the non-treated metal within reinforced cement. More preferably, the improvement is at least 25%, and most preferably it is at least 50%.

In a ninth aspect of the invention, the metal reinforcement includes, but is not limited to, rebar or metal mesh or any other type of non-cement structure that provides additional strength to the hardened cement, particularly where the non-cement structure is reactive to corrosion.

In a tenth aspect of the invention, the mending of the targeted area by released aqueous mending agent microcapsules reduces water transport through the hardened cement due to reduced porosity and decreased interconnectivity of cracks. The mending of the cracks will also inhibit the ingress of damaging chlorides, thereby reducing the rebar corrosion rate.

In an eleventh aspect of the invention, the metal reinforcement may be pretreated with aqueous mending agent microcapsules at any time prior to the addition of the cement matrix.

In a twelfth aspect of the invention, the aqueous mending agent microcapsules may be produced, selected, and/or additionally treated to provide for enhancing the surface and physical properties of the microcapsules to adhere to the metal reinforcement. In a further aspect, the metal reinforcement may be treated to enhance its binding capacity or properties to the microcapsules.

In a thirteenth aspect of the invention, a composition of cement matrix containing a plurality of microcapsules and an aqueous mending agent in the microcapsules is provided wherein the microcapsules releases the aqueous mending agent upon stress.

In a fourteenth aspect of the invention, a composition is provided for the treatment metal reinforcement within hardened cement, wherein the composition contains a plurality of microcapsules, an aqueous mending agent in the microcapsules, in addition to the metal reinforcement. In accordance with a further aspect of the invention, the metal reinforcement is treated at any time prior to the addition of a cement matrix.

As used herein, the term “cement matrix” means any material containing cement materials including materials containing pebbles or rocks, such as concrete, and the incorporation of strengthening materials, not limited to fibers.

As used herein, the term “microcracks” means cracks that are between 10 to 400 microns in width.

As used herein, the term “self-healing” or “healing” means any agent that improves the properties of cement matrix upon release of the self-healing agent and may include a catalyst or activator that reacts with its self.

As used herein, the term “self-mending” or “mending” means any agent that improves the properties of cement matrix upon release of the aqueous mending agent by bonding with endogenous hydration by-products of the damaged concrete and forming a natural cement bond.

### BRIEF DESCRIPTION OF DRAWINGS

The invention may be further understood with reference to the following drawings in which:

FIG. 1 shows an illustrative diagrammatic representation of adding microcapsules containing the aqueous mending agent into a concrete mixture, as well as the application of a load to hardened concrete and the rupturing of the capsules, releasing the mending agent that can repair the cracks responsive to the mechanical stress from the application of the load;

FIG. 2 shows an illustrative representation of a light microscopy image of a polyurethane microcapsule synthesized through an interfacial polymerization;

FIG. 3 shows an illustrative representation of a hardened cement material having a crack that propagated through the material;

FIGS. 4A and 4B show illustrative graphical representations of load versus displacement (extension) for flexural strength characterization of a control material and a material containing microcapsules in accordance with an embodiment of the invention; and

FIG. 5 shows an illustrative graphical representation of open circuit potentials versus time for corrosion and capsule samples in an electrochemical experiment.

The drawings are shown for illustrative purposes only.

### DETAILED DESCRIPTION OF THE INVENTION

In accordance with the present invention, it has been discovered that a self-mending process may be employed that is targeted to areas of hardened cement that have undergone stress, by incorporating microcapsules within the cement mixture. The microcapsules contain mending agents that when ruptured (by stress within the hardened cement) release the aqueous mending agent in the area of the stress. The aqueous mending agent naturally and covalently bonds with the by-products of concrete hydration in the damaged concrete, improving one or more properties of the concrete as well as reducing corrosion of metal reinforcement incorporated in the concrete.

The encapsulated aqueous mending agent is one that does not require any additional factors such as catalysts or initiators, and has a natural cement bond with an endogenous cement hydration by-product in damaged targeted areas. The invention further provides that corrosion of metal reinforcement material encased by the cement matrix may be reduced. The invention additionally provides for a method of pretreatment of metal reinforcement material at any time prior to the addition of the cement matrix to reduce corrosion in microcracks formed by external stress.

The present invention involves the discovery that an aqueous mending agent may be encapsulated into microcapsules and incorporated into a cement matrix, whereby upon targeted release from microcapsules caused by stress the aqueous mending agent reacts with endogenous products of cement hydration in the damaged concrete to produce a natural cement bond that mends the damaged concrete.

A targeted event producing a microcrack may be caused by a variety of stress factors that act as a trigger for the self-mending process to occur in the localized region. Preferably, microcapsules containing an aqueous mending agent core are incorporated within the concrete matrix in the absence of any other additives, such as catalysts or activators, to promote or stimulate mending. When mechanical or other stress is applied, the microcapsules rupture releasing the aqueous mending agent into the microcracks formed by stress and the aqueous mending agent bonds with the damaged concrete improving at least one of its physical properties.

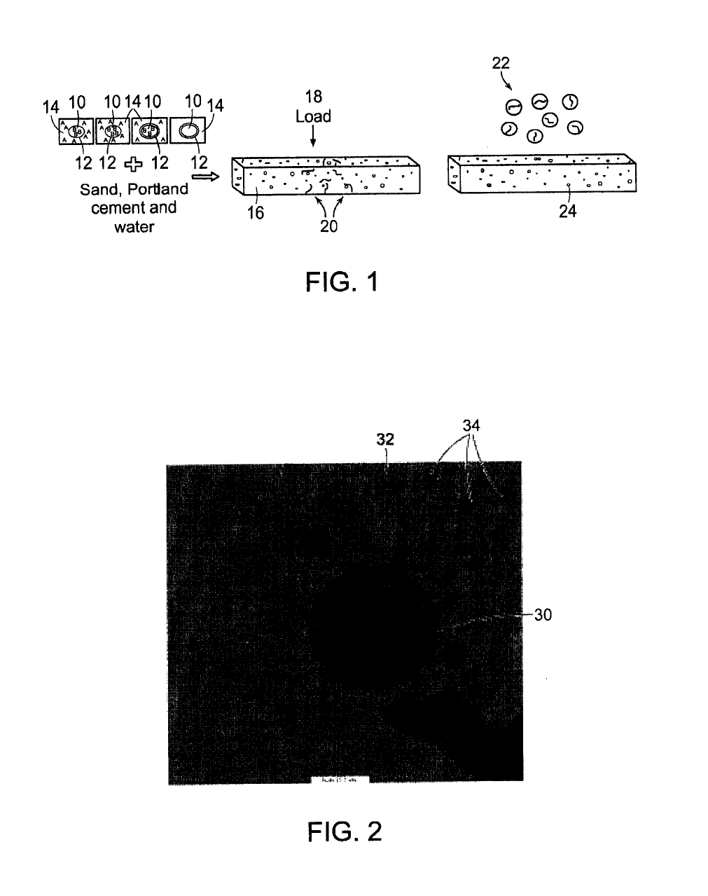

As diagrammatically shown in FIG. 1, for example, the mending agent 10 is encapsulated in microcapsules 12 in a cement mixture 14, of sand, Portland cement and water. The cement mixture is poured and hardened to provide a hardened cement structure 16. A load is applied (as indicated at 18), and small cracks 20 appeared in the structure 16. The mending agent is released from the microcapsules 20 when the stress is applied and the cracks form. The mending agent flows into the small cracks 20 and bonds at a molecular level to the surfaces of the cracks as diagrammatically shown at 22 to provide a mended structure 24.

In one example of the invention, sodium silicate reacts with calcium hydroxide, a product of cement hydration, and produces a calcium-silica-hydrate (C—S—H) gel—a binding material natural to concrete. A key aspect of the invention is that the mending agent resides in an aqueous environment within the microcapsule and the water facilitates the hydration of the damaged cement and subsequent bonding of the mending agent. The C—S—H gel (x.(CaO.SiO₂).H₂O) fills the crack, and allows recovery of strength. The relevant chemical reactions are shown below:

Na₂O.SiO₂+Ca(OH)₂→x(CaO.SiO₂).H₂0+Na₂O

x(CaO.SiO₂).H₂0+Na₂O+CO₂→CaCO₃+SiO₂+2NaOH

C—S—H is a complex product that often has varying CIS ratios present and may differ slightly in nanostructure. It has been demonstrated in hydrated cement and is described as a network of nanoparticles. For this invention, only the first reaction forms the product rapidly. It is the newly formed C—S—H gel that will act as a binder and mender in cracks and pores, bridging the gaps in the material and ultimately improving its strength. The second reaction is a longer time scale. Sodium-silica-hydrate (N—S—H) is observed in concrete as a result of the reaction between sodium hydroxide and silica. The long-term products initiated by the presence of the aqueous mending agent provides further integrity of the concrete. In addition to sodium silicate, other mending agents include calcium nitrite.

This present invention is not limited to the use of microcapsules as the aqueous mending agent may be delivered using hollow fibers or other shapes provided that the mending agent may be incorporated in the shape and that stress may be used to release the mending agent. The size of the shaped enclosures may be on the order of 10 to 1000 microns. The desired properties of microcapsules may depend upon a variety of attributes that include, but are not limited to, resistance to aggregation, whether they become uniformly dispersed in a cement mixture, temperature stability, long shelf life, capsule wall thickness, and resistance to mixing when added to the cement mixture.

The mixture for forming microcapsules containing a mending agent includes at least an aqueous mending agent solution, a surfactant, and a polymerizer. This invention preferably excludes the use of any other agents, catalyst or activators, or external stimulus that initiate the mending action. The mending agent solution is an aqueous solution of the mending agent having a concentration of 0.1% to 10% weight of mending agent per volume of water. Polymers used for production of microencapsules may include a polyurethane precursor such as a diol, a diisocyanate, and/or a monomer containing both alcohol and isocyanate functional groups. In other examples of polymers, the polymer precursor may include a urea-formaldehyde polymer precursor, such as urea and/or formaldehyde. In yet other examples of polymers, a polystyrene precursor, such as styrene and/or divinylbenzene; or a polyamide precursor, such as an acid chloride and/or a tramine. This invention is not limited to the microcapsules prepared as described herein and includes any and all materials regardless of composition and shape that provide for the containment of the aqueous mending agent that may be released upon stress.

Microcapsule properties such as the walls of the capsules or aggregation may be adjusted using ionic surfactant, such as a cationic surfactant, an anionic surfactant, or an amphoteric surfactant or non-ionic surfactant. The process of dispersing the mixture may use a variety of protocols including mechanical agitation, magnetic stirring, vortexing, and high pressure jet homogenizing. Additional methods may be employed during or after the production of microcapsules to provide a more uniform diameter using either controlled processing or selection of microcapsules sizes using centrifugation, sonication or other post-production methods.

The present invention incorporates aqueous mending agent microcapsules into the cement matrix by blending microcapsules into the wet cement mixture and constitute between 0.5% to 25.0% of the total weight of the cement mixture. The aqueous mending agent microcapsules may be added initially or just prior to pouring the cement mixture into the molded article.

Preferably, the incorporation of the aqueous mending agent microcapsules restore at least one of the cement properties to a level of at least 10% compared to the non-incorporated control cement, more preferably at least 25%, and most preferably at least 50%.

The present invention further provides for reducing the corrosion of metal reinforcement incorporated in the cement for strengthening properties. Examples of metal reinforcement include, but are not limited to, rebar or metal mesh or any other type of non-cement structure that provides additional strength to the hardened cement structure. Metals include any and all metals that are reactive to corrosion. When stressed, the mending agent is released and some of the aqueous mending agent deposits on the metal reinforcement bars (rebars) traditionally used in concrete. The formation of a passive film on the surface of the metal will provide protection of the metal reinforcement from corrosion. Additionally, the mending of the targeted area will reduce water transport through the concrete matrix due to reduced porosity and decreased interconnectivity of cracks. The mending of the cracks will inhibit the ingress of damaging chlorides, thereby reducing the rebar corrosion rate.

A further aspect of the present invention involves the treatment of metal reinforcement prior to the addition of the cement matrix. Microcapsules may be produced, selected, and/or additionally treated to provide for enhanced surface and physical properties to adhere to the metal reinforcement. Further, the metal reinforcement may be pretreated to enhance its binding capacity or properties to the microcapsules. Preferably, the pretreatment of the metal reinforcement reduces corrosion by at least 10% compared to the non-treated metal reinforced cement, more preferably at least 25%, and most preferably at least 50%.

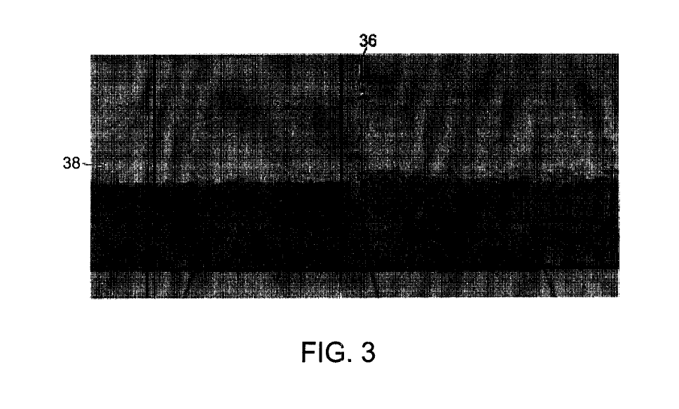

The in situ synthesis using an interfacial polymerization is described in the following steps. 4.202 mL of sorbitan trioleate (Span 85) and 2.116 mL of polyethyleneglycol (PEG) were dissolved in 90 mL of toluene. A 15 mL aliquot was taken from this solution and placed into a separate beaker (referred to as E₁). 0.682 mL of methylene diiosocyanate (Basonat) and 0.0469 mL of dibutyl tin dilaureate was dissolved in E₁. This blend was mixed at 350 rpm to ensure a homogenous mixture and set aside. The original mixture (Span 85, PEG and toluene) was combined with 30 mL of water, stirring at 8000 rpm in a homogenizer or blender. Finally, E₁ was added to this primary emulsion and stirred at 700 rpm for 10 minutes at room temperature. The speed was reduced to 350 rpm at 63° C. and allowed to react for 4 hours. An optical microscope image of a polyurethane microcapsule 30 within a cement mixture 32 is shown in FIG. 2. The cement mixture also includes stones and sand 34. Microcapsule sizes varied in size from 40-800 microns.

Concrete samples were prepared to the specifications of ASTM C-109 with a mix containing 1375 grams of Ottawa C-109 sand, 500 grams of Type I/II Portland cement and 242 mL of water. For samples containing the polyurethane microcapsules, the capsules were added to the mix water at 2% volume and prepared identical to the control samples. Molds of dimensions 160 mm×40 mm×20 mm (for flexural strength) and 500 mm×500 mm×500 mm (for compressive strength) were used. After being stripped from the molds, the specimens were submerged in water for two days then contained in a 95% constant humidity environment for 28 days to ensure full curing.

For mechanical strength testing, randomized internal microscale damage was induced with an applied load to incipient failure, to mimic realistic cracking patterns. For the corrosion testing, one large crack was induced directly to the iron wire to ensure a common path between samples.

For the flexural strength tests, approximately 160 mm×40 mm×20 mm samples were used. Each sample was subjected to an applied load of 0.25 mm/min to induce microcracking within the sample. The cracking was minor and internal only and meant to mimic microscale damage and deformations that occur within the concrete after applied or natural stress, and prior to catastrophic failure. After one week, these samples were retested to see how much strength has been recovered after the initial damage.

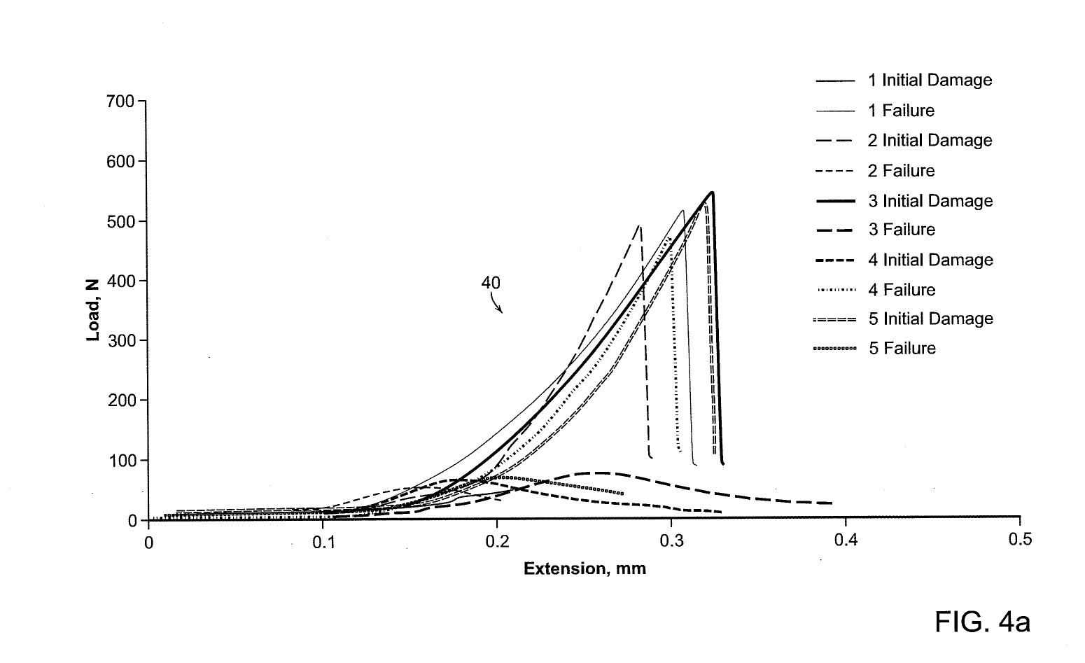

For the corrosion experiments, a larger, single crack was induced to give the sodium chloride solution a direct and common path to the iron wire in each sample. This was achieved by subjecting the 160 mm×40 mm×20 mm samples to a three point bend test so that a crack propagated directly to the wire upon failure. An example of a representative sample 38 with a crack 36 is shown in FIG. 3.

The experimental procedure to determine the compressive strength of each specimen was adapted from ASTM C109. Each sample was centered between the two parallel discs. The strain rate is 1 mm/min. For the first test, the load was stopped after the sample had reached a maximum load and shows a gradual descent, but was not allowed to reach failure. After the short term mending time had passed, each sample was retested to failure. Only the results of the retested samples are presented herein.

The results of the compressive strength re-test for 5 control samples and 5 samples containing microcapsules are presented in Table 1. No loss was found in compressive strength for the capsule-containing samples.

TABLE 1
Compressive Strength in Control and Microencapsulated Samples.

| Sample | Control, strength (ksi) | With 2% vol. microcapsules (ksi) |
|---|---|---|
| 1 | 2.279 | 2.253 |
| 2 | 2.283 | 2.307 |
| 3 | 2.247 | 2.875 |
| 4 | 2.244 | 2.579 |
| 5 | 2.276 | 2.718 |

The microcapsules proved to be a highly effective way of encapsulating the mending agent for a targeted release. The results from the compressive strength tests show that the capsules do not interfere with the cementitious matrix.

The experimental procedure to determine the flexural strength of each specimen was adapted from ASTM C348-97. The flexural strength was measured by means of a three-point bend test. Samples were supported by two parallel beams and compressed by one central beam. The load was set to move at 0.25 mm/min. For the first test, the load was stopped after the sample had reached a maximum load and showed a sharp descent, but was not allowed to reach failure. After the mending time had passed, each sample was retested to failure.

The subsequent experiment was used to evaluate whether the material was able to recover some of its strength after acquiring some minor, microscale damage. First, the sample was loaded to incipient failure, indicated by the sharp decrease in the load-displacement curve. The samples were then left to mend for one week. During this time period, the aqueous mending agent that was released from the capsules had time to react with the calcium hydroxide to form the C—S—H, filling some of the cracks that have formed.

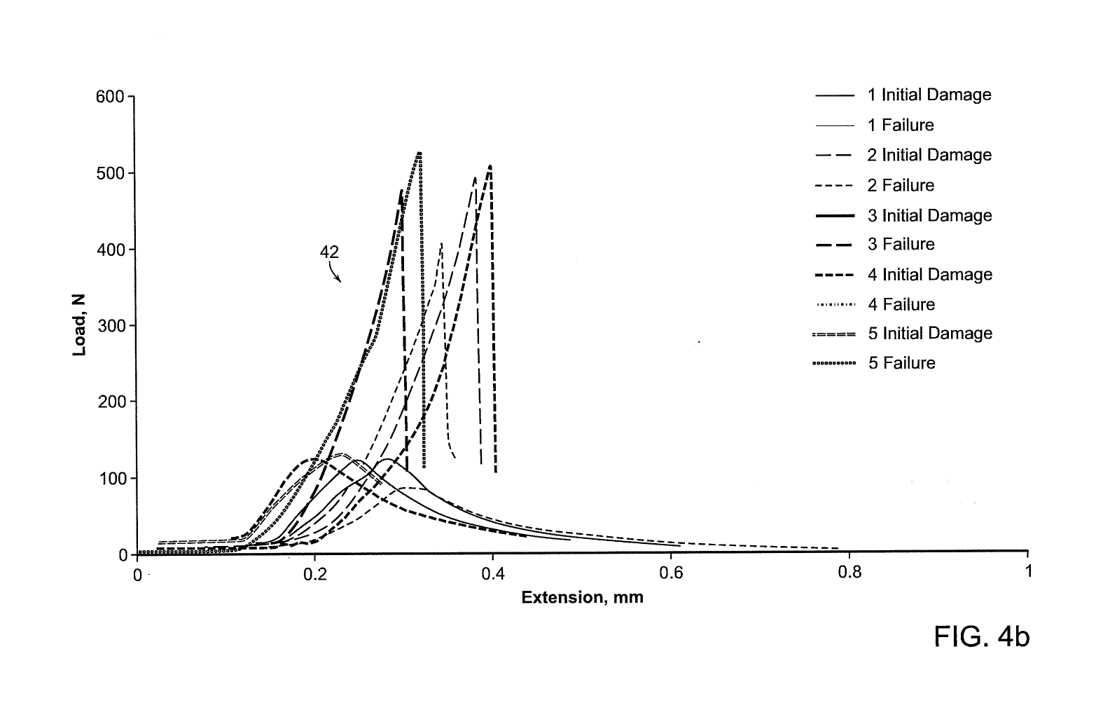

The results for 5 control samples and 5 samples containing the microcapsules are shown at 40 and 42 respectively in FIGS. 4A and 4B, and are summarized in Tables 2 and 3.

TABLE 2
Flexural Strength in Control Samples.

| | Initial Max Load, | Max Load After Damage, | |
|---|---|---|---|
| Sample | N | N | Recovered, % |
| 1 | 512.9 | 46.7 | 9.11 |
| 2 | 490.7 | 57.6 | 11.7 |
| 3 | 541.9 | 76.6 | 14.1 |
| 4 | 470.6 | 66.4 | 14.1 |
| 5 | 525.8 | 69.6 | 13.2 |

TABLE 3
Flexural Strength in Microencapsulated Samples.

| | Initial Max Load, | Max Load After Damage, | |
|---|---|---|---|
| Sample | N | N | Recovered, % |
| 1 | 495.7 | 124.4 | 25.1 |
| 2 | 416.7 | 85.9 | 20.6 |
| 3 | 476.6 | 125.2 | 26.2 |
| 4 | 513.8 | 127.5 | 24.8 |
| 5 | 528.2 | 130.5 | 24.7 |

Strength recovery was reported as a percentage of the maximum strength reached after minor damage has been induced compared to the maximum strength in the initial test. The control samples had about 10%-14% of its initial strength left after microscale damage had occurred. The samples containing the microcapsules restored 20%-26% of its flexural strength after the damage. Compared to control samples, the aqueous mending agent microcapsules restored 43% to 260% more of cement flexural strength. This was indicative of the capsules rupturing where the cracks were initiated, partially mending them and providing more strength to the samples in the second test. Ultimately, this type of mending is desired to promote a longer life of the material since it is prolonging the time to failure.

The area under the stress-strain curve was obtained to provide a measure of the toughness of the material and is summarized in Tables 4 and 5. Compared to the average of the control samples, concrete samples containing the aqueous mending agent microcapsules restored 85% more of cement toughness.

TABLE 4
Toughness of Control Samples.

| Control | Toughness (N-mm), initial damage | Toughness (N-mm), Failure |
|---|---|---|
| 1 | 31.5 | 11.6 |
| 2 | 24.0 | 4.6 |
| 3 | 42.6 | 20.1 |
| 4 | 28.9 | 7.8 |
| 5 | 31.5 | 11.8 |
| Average | 31.7 | 11.2 |

TABLE 5
Toughness of Capsule-Containing Samples.

| | Toughness (N-mm), | Toughness (N-mm)s, |
|---|---|---|
| Capsule | initial damage | Failure |
| 1 | 35.9 | 24.4 |
| 2 | 27.4 | 14.9 |
| 3 | 22.6 | 20.8 |
| 4 | 34.1 | 21.2 |
| 5 | 39.9 | 22.9 |
| Average | 31.9 | 20.8 |

High strength concrete exhibits a brittle behavior in which cracks quickly propagate. This was displayed in the initial test of the flexural data in which a linear relationship was interrupted by a sharp decrease in the load (FIG. 4). After the initial damage has been done, the material exhibits a much more ductile behavior. This was more evident in the capsule-containing samples, and results in higher toughness than the controls.

A critical ability of the invention was demonstrated in testing the flexural strength after inducing microcracks, where the presence of the microcapsules restored the material performance by at least 10% compared to the control samples.

A 0.5M solution of sodium chloride was used to represent the ingress of chlorides to the steel reinforcement bars in concrete. An acrylic well was adhered to the surface of each rectangular sample with 3M 5200 Adhesive Sealant to ensure a tight, waterproof seal. The cylindrical well is 3 centimeters in diameter and was located directly over the wire present at the center of each sample. The bottom face opposite the well was fixed with a piece of Parafilm and all other surfaces were sealed with duct tape. A piece of sandpaper was used to sand off any rust or impurities that may have built up on the iron wire during curing and to ensure a good connection of the voltmeter to the wire. A potassium chloride reference electrode was placed in the empty well. The sodium chloride was poured into the small well and allowed to travel through the pores and crack to reach the iron wire. The voltage of the wire was recorded over time until the wire was corroded internally.

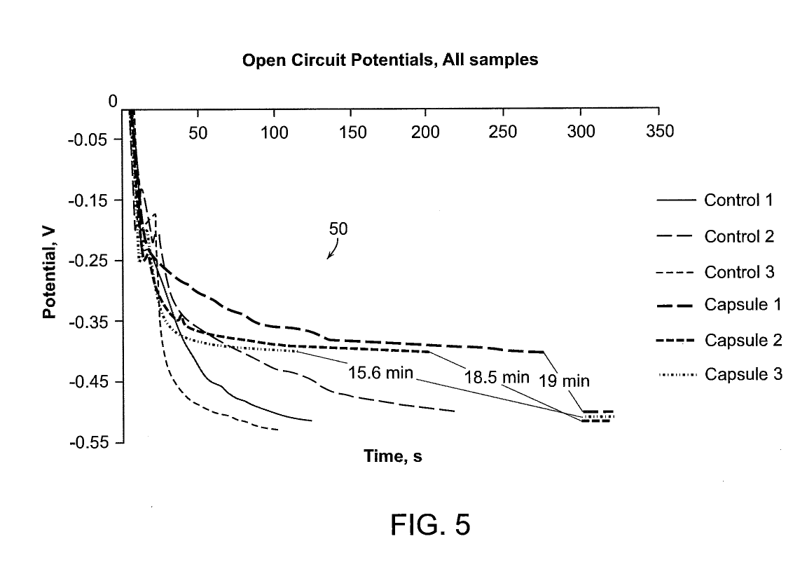

The most common and routine inspection of reinforced concrete was used to monitor the open circuit potential of the rebars to monitor and detect corrosion. A voltage potential higher than −0.200V implied a low risk of corrosion. If the potential was between −0.200V to −0.350V, it was an intermediate level of corrosion. If the potential dropped below −0.350V, there was a high risk of corrosion. Finally, reaching a potential of −0.500V was indicative of severe corrosion. For the results presented here, each sample was subjected to the sodium chloride solution until it displayed severe corrosion, or the potential reached −0.500 volts. A graphical representation of the results is shown at 50 in FIG. 5.

A rapid decrease in potential was observed when the sodium chloride was first poured into the well. In less than 40 seconds, each of the control samples had reached a potential near -0.350V, which indicated there was already a high risk of corrosion to the wire. Control 1, 2 and 3 lasted 96 s, 118 s and 212 s, respectively, after which they all were severely corroded.

Capsule samples 1, 2 and 3 also showed a rapid decrease in potential initially, similar to the control samples. The potential reached -0.350V in 86 s, 30 s and 40 s, respectively. Beyond this point, however, the capsule containing samples showed a significant difference from the control samples. The potential was sustained at this intermediate corrosion level. The voltage very gradually decreased to −0.400V in 276 s, 200 s and 124 s, respectively. The time taken for these samples to reach a voltage of −0.500 volts was indicated in the figure. Capsule sample 3 exhibited the shortest time period, going from −0.400 to −0.500 volts in 15.6 minutes. Capsule sample 2 followed with 18.5 minutes until severe corrosion and finally, the first sample lasted the longest with 19 minutes of elapsed time before severe corrosion was observed. The key observation was a significant retardation in corrosion in the capsule containing samples.

Two mechanisms for corrosion inhibition are therefore presented herein in accordance with various embodiments of the present invention. The first involves the formation of a passive layer to protect the metal. In the second, the ruptured capsule would fill the cracks and reduce porosity and interconnectivity to decrease the solution introduction rate. The initial corrosion rates were very similar, shown by a sharp, sudden decrease in the potentials of each sample. The control samples exhibited uniform corrosion. The chlorides permeate through the concrete quickly and severe corrosion is observed. The capsule-containing samples were able to sustain the intermediate potential. This behavior was explained by a combination of both the mending properties and passive layer. First, there was a presence of a thin passive layer that formed from the effects of the ruptured capsules. The chlorides moved quickly through the path of least resistance, which was the large, induced crack directly to the wire, and affected any of those areas not protected by the passive film. These areas would be easily corroded, explaining the similarity in the initial corrosion rate and potentials. With some passive layer present, however, it would take the chlorides longer to have a similar affect on the wire compared to the control samples, which explains why the time taken for the potential to reach the intermediate level of corrosion at −0.350 volts was longer. The results for the capsule-containing samples showed a significant amount of corrosion inhibition compared to the control samples. With increased capsule loading (optimized for strength), more silicates can be deposited onto the wire to form a passive layer that could protect it for greater time. An added approach is the pre-treatment of metal reinforcement with microencapsulates optimized for adherence to the metal reinforcement surface. An ideal application for this system would be as an added aid for corrosion inhibition in an already protected structure.

Those skilled in the art will appreciate that numerous modifications and variations may be made to the above disclosed embodiments without departing from the spirit and scope of the present invention.

What is claimed is:

1. A cement mixture including an aqueous mending agent that is disbursed within but isolated from the cement mixture, wherein the aqueous mending agent will form molecular bonds with hardened cement that is formed by the cement mixture when the mending agent is permitted to flow within the hardened cement.

2. The cement mixture as claimed in claim 1, wherein the mending agent includes one of sodium silicate.

3. The cement mixture as claimed in claim 1, wherein the mending agent includes one of calcium nitrite.

4. The cement mixture as claimed in claim 1, wherein the mending agent is encapsulated in microcapsules within the cement mixture.

5. The cement mixture as claimed in claim 1, wherein the microcapsules are formed of any of polyurethane, urea-formaldehyde polymer, a polystyrene, polyamide and gelatin.

6. The cement mixture as claimed in claim 5, wherein the microcapsules have diameters on the order of 10 to 1000 microns.

7. A cement mixture including an aqueous mending agent that is disbursed within but isolated from the cement mixture, said aqueous mending agent including at least one of sodium silicate and calcium nitrite.

8. The cement mixture as claimed in claim 7, wherein the mending agent is encapsulated in microcapsules.

9. The cement mixture as claimed in claim 7, wherein the mending agent, when in contact with hardened cement, forms calcium-silica-hydrate.

10. A method for mending cement damaged by a stress comprising; encapsulating an aqueous mending agent within a microcapsule, adding the aqueous mending agent microcapsule to cement matrix, pouring the cement matrix containing the aqueous mending agent microcapsule into a form, releasing the aqueous mending agent microcapsule by stress, and forming a natural cement bond, thereby improving at least one property of the damaged cement.

11. The method as claimed in claim 10, wherein the aqueous mending agent is selected from aqueous sodium silicate and calcium nitrite.

12. The method as claimed in claim 10, wherein the aqueous mending agent is a solution of 0.1 to 10% mending agent.

13. The method as claimed in claim 10, wherein the microcapsule is selected from a group consisting of polyurethane, urea-formaldehyde polymer, a polystyrene, polyamide and gelatin.

14. The method as claimed in claim 10, wherein the stress is selected from a group consisting of freezing, thawing, loading, cracking, impacting, corrosion, weight, chemical, creep, expansion, and shrinkage.

15. The method as claimed in claim 10, wherein the damaged cement property is selected from a group consisting of tensile strength, toughness, porosity, and water permeability.

16. The method as claimed in claim 10, wherein the mending microcapsule is added to the cement mixture in an about of from 0.5% to 25.0% by weight.

17. The method as claimed in claim 10, wherein the cement matrix containing the aqueous mending agent microcapsule is poured into a form containing a metal reinforcement.

18. The method of claim 17, wherein the aqueous mending agent reduces corrosion of the metal reinforcement by releasing the aqueous mending agent microcapsule by stress.

19. A method for reducing corrosion by treating the metal reinforcement with aqueous mending agent microcapsule prior to pouring the cement matrix with or without aqueous mending agent microcapsule into a form.

20. The method of claim 10, wherein the metal reinforcement is pretreated to enhance its binding capacity or properties to the aqueous mending agent microcapsule.

21. A composition for mending cement damaged by a stress comprising; a plurality of microcapsules and an aqueous mending agent in the microcapsules, wherein the microcapsules release the aqueous mending agent upon stress.

22. The composition of claim 21 for reducing corrosion, wherein the cement matrix containing the aqueous mending agent microcapsule is poured into a form containing a metal reinforcement.

23. A composition for reducing corrosion of metal reinforcement, wherein the metal reinforcement is treated with aqueous mending agent microcapsules prior to pouring of the cement matrix.
